(19) United States
(12) Patent Application Publication
(10) Pub. No.: US 2007/0118451 A1
(43) Pub. Date: May 24, 2007

(54) Investment method

(76) Inventor: Julian N. Schneider, Houston, TX (US)

Correspondence Address: TIMOTHY F. MILLS, 1177 WEST LOOP SOUTH, SUITE 400, HOUSTON, TX, 77027-9012, US

(21) Appl. No.: 11/413,378

(22) Filed: Apr. 29, 2006

Related U.S. Application Data
(60) Provisional application No. 60/738,681, filed on Nov. 21, 2005.

(51) Int. Cl. G06Q 40/00

(52) U.S. Cl. 705/36 R

(57) ABSTRACT

A low-risk or no-risk method of realizing investment gain on a loan by borrowing at a fixed rate at simple interest and investing the loan proceeds in an insured or otherwise guaranteed financial product, such as a Certificate of Deposit, providing compound interest income in excess of the borrowed interest and expenses. A gain occurs when the combined amount of the original investment of the loan proceeds plus the accumulated interest income exceeds the remaining balance of the related mortgage loan and any expenses.

### CROSS-REFERENCE TO RELATED APPLICATION

Applicant claims the benefit of priority from U.S. Provisional Patent Application No. 60/738,681, filed by the Applicant herein, Julian N. Schneider, on Nov. 21, 2005.

### STATEMENT REGARDING FEDERALLY FUNDED SPONSORED RESEARCH OR DEVELOPMENT

Not applicable.

### BACKGROUND OF THE INVENTION

1. Field of the Invention

The present invention relates generally to borrowing money and investing it for gain. The term, ‘gain’, as used throughout this document has the meaning stated in the Online Merriam Webster Dictionary of “resources or advantage acquired or increased”, and stated as synonymous with “profit”, which are incorporated herein by reference.

More particularly by borrowing money at the lowest possible rate and investing the borrowed funds, providing the interest income would exceed the borrowed interest expense. More particularly, it involves borrowing money at the lowest possible fixed simple interest rate and investing the borrowed funds at compound interest so that the interest income exceeds the borrowed interest expense. Specifically, it involves borrowing from home or asset equity at a low fixed rate at simple interest, and investing the money in Certificates of Deposit (CDs) providing compound interest income in excess of the borrowed interest and expenses. A gain occurs when the combined amount of the original investment of the loan proceeds, after any lending expenses, plus the accumulated interest income exceeds the remaining balance of the related mortgage. In addition, if invested in insured or otherwise guaranteed CDs or other funds, the invested equity has the security associated with investing in instruments guaranteed by the Federal Deposit Insurance Corporation of the United States government.

In the year 2005, the spending rate for the population of the United States exceeded the saving rate by one-half (½) of one percent. This may be the first time that this has occurred since the Great Depression years of 1932 and 1933. By using the investment method and security of the present invention even people with minimal risk tolerance for investment will be encouraged to borrow and invest with (1) no fear of losing their principal and (2) be guaranteed of making a gain. One basis of our government and economic system is based upon increasing the wealth of our society by personal savings. Unconsumed income is one way wealth is created long term. If we continue to consume our entire income, we as an economy will become poorer. The equity investment method of the present invention is a novel method of accumulating savings over a long period of time concurrent with a home or asset mortgage, thereby increasing individual savings and the value of the national economy.

The no-risk or low investment risk premise of the present invention used throughout this disclosure is based upon using bonds, CDs or other financial products insured, by a local, state, or the federal government, or otherwise guaranteed. In that sense, the risk is controlled by the presence and financial soundness of the government program, for example the FDIC established and funded by Congress, and backed by the U.S. economy. However, other financial products with controlled or known risk may also be employed to minimize or otherwise quantify investment risk in accord with the method of the present invention.

In regard to investment by individuals and homeowners, the majority of investment in our society is made by people in the upper ten percent income bracket since they have the extra personal capital to risk. In comparison, lower and middle income people do not easily accumulate extra funds to invest since their entire income is required for the expenses of daily living, including but not limited to food, clothing, shelter, transportation and medical care. However, the method of the present invention allows even lower and middle income people to borrow, for example, against home equity, and be guaranteed a profit on their investment without fear of loss. It enables an entire segment of the population not previously involved in investing to become a participant and a beneficiary of our economic system. For example an individual who has just paid down or paid off the home mortgage may now borrow a portion of the home equity to invest in the manner prescribed in the present invention and not be concerned with the loss of principal and be guaranteed a profit.

2. Description of Related Art

Borrowing home equity to invest in financial products that would generate capital appreciation has been referred to as “stripping.” This is not novel but the current methods involve significant risk and are generally only useful to sophisticated investors who can manage the investment or maintain close control. In the Jan. 17, 2005, issue of MORTGAGE NEWS DAILY, an article entitled “Stripping Makes It To The Big Time,” related that “stripping” the equity from the home to invest in appreciating instruments would generate a whole new stream of capital income which would cover the payments on the home equity mortgage and the stocks. But there is no advice on how to accomplish this goal without significant risk. In a commentary in the Sep. 26, 2005, issue of Mortgage News Daily the author reviewed this article on “stripping” and discussed the downside of this strategy with a warning to the members of the National Association of Security Advisers of their liability in cases where clients even lost their homes following this type of advice. This Mortgage News Daily commentary cites five circumstances in which this strategy may be considered, (i) the financially secure investor, (ii) limit the amount “stripped” to no more than twenty (20%) percent of home value, (iii) arbitrage when a mortgage company offers a temporary “teaser” loan at a very low rate and then invest the proceeds in a higher yielding CD with a comparable maturity, (iv) concern that home value may drop so investing in another investment category is a good idea, and (v) use the acquired funds to augment income, so the investor can afford to contribute to a 401-K, which the employer is matching generously. But the risk and liability are significant factors to be factored into this method of stripping and require the skill and attention of a sophisticated investor. In comparison, the method of the present invention utilizes a no-risk to low risk investment product such as a CD. Therefore anyone who can buy a CD can utilize the method and use it to accumulate savings.

In an article titled, “Investing Equity-What Do You Do,” in the Sep. 12, 2005, edition of GARDEN WEB HOME PAGE, the article discussed a couple who converted their conventional fixed rate mortgage to an adjustable rate mortgage to strip out the equity at a lower rate and invested the amount with a “financial advisor”. Some responders to the article had negative comments about the couple's judgment and the “advisor”. The last responder made the most worthwhile comments, emphasizing the risk factor. He noted that the only risk comparison with a mortgage was a treasury bond which always has a lower rate than mortgages thus implying that it would be disadvantageous to invest in an instrument that produced a lower rate of return.

Thus, advisors always compare the rates of the mortgage to the investment rates and require that the investment rates be higher. Another commenter related similar advice in that the couple should only invest in a conservative investment. But that commentator noted that the only equally conservative investment would be a CD and then questioned where a 6% CD could be purchased. Therefore, these knowledgeable advisors did not and would not consider that a lower than mortgage rate CD could earn more than a higher rate mortgage would cost over time, as demonstrated by the present invention.

Similar advice has been rendered regarding whether to pay cash for a residence or merely make a small down payment and invest the remainder to cover the mortgage payments plus provide a gain. In the Commentary section of the publication, YOUR MONEY, readers responded to an E-mail dated Jun. 3, 2005, with various arguments of the advantages and disadvantages of paying cash for a residence versus making a small down payment and investing the remainder of the cash. The most relevant letter came from a Mortgage Company advising investing the excess cash in a 3.7% CD which adjusted for taxes would amount to 5.5%, a rate equal to the mortgage rate. In a rising interest environment, the CD rates will exceed the mortgage interest of 5.5% and you will be ahead. However, once again the advisors are requiring that the CD rates be higher than the mortgage rates to realize a gain. The method of the present invention demonstrates that this relationship is not required in that the CD rate can be lower during the entire term of the mortgage than the mortgage rate and still the investor will realize a gain. In addition, the mortgage companies generally assume that the borrower is itemizing deductions and not taking the standard tax deduction available on Schedule 1040. The method of the present invention does not require that the borrower itemize to increase the return on the borrowed funds to a comparable rate to the mortgage rate.

In U.S. Pat. No. 5,644,726, issued Jul. 1, 1997, to Oppenheimer, the inventor related a method to solve a problem encountered by mortgage companies where they lend money for long terms at low interest rates but have to pay depositors more for their money as interest rates rise over the life of the mortgage. At the end of the life of the mortgage, the homeowners have property that has appreciated greatly in value but the lender has no equity in that appreciation. The method of Oppenheimer would require that as a condition of borrowing money at a low rate the homeowner would grant an equity interest in future appreciation to a ‘joint venture partner’ (JVP). The JVP lends a portion of the original mortgage at a lower rate than the mortgage company rate and in return the borrower pledges a portion of the appreciation as security. The borrower benefits initially from lower monthly payments than would have been paid on a traditional mortgage, and the JVP benefits by receiving a premium on their portion lent at below market rate. Thus the borrower is partially obligated to the mortgage company and partially to the JVP. After the borrower pays the mortgage company, he then pays the JVP a portion of the appreciated value of the property. This method has no relationship to the method of the present invention and it only has an option of providing the mortgage lender with the collateral of the invested mortgage proceeds.

In U.S. Pat. No. 5,832,461, issued Nov. 3, 1998, Leon et al., devised a method of using data processing to manage the functions of depositors, marketing intermediaries, mortgage brokers, and borrowers in an inflation adjusted financing program. This method is similar to other patents and ideas that attempt to share the burden of inflation with the borrower and the financial institution by dividing the benefit of the appreciation of the property between the borrower and the financial institution. This method differs from the method of the present invention in that it is not the purpose the present invention to distribute the cost of inflation or the benefit of property appreciation between the borrower and the financial institution. Pursuant to the method of the present invention the borrower benefits directly from inflation and property appreciation.

U.S. Pat. No. 5,907,828, issued May 25, 1999, to Meyer et al., discloses a method to manage mortgage customer life insurance by data processing for the protection of the lending institution. By comparison, using the method of the present invention the institution is protected by having the double collateral of the property and an assignment of the investment in the CDs to the lending institution until the investment in the CDs equals the balance of the mortgage. This balance is accomplished as the investment in CDs accumulates with the compound interest and the mortgage is diminished by regular monthly payments.

Therefore there exists a need to provide a method of investing funds, for example, home equity, to provide a no-risk or greatly reduced risk of return or gain greater than the home equity mortgage interest and expense. The review of the literature above suggests that a gain cannot be realized if the mortgage interest rate is greater that the invested interest rate. However, the present invention demonstrates that by combining in a loan a rate utilizing standard fixed simple interest and an investment product utilizing compound interest, that the mortgage simple interest rate may be greater than the investment compound interest rate but a gain would still be realized.

### BRIEF SUMMARY OF THE INVENTION

The method of the present invention utilizes a concept in economics and finance of two concurrent interest markets. Recent economic and financial thinking has referred to the non-response of long term interest rates to increases in the Federal Reserve Funds rate as a “conundrum” (Testimony of the Federal Reserve Board Chairman, Alan Greenspan, to the Committee on Banking, Housing, and Urban Affairs, of the United States Senate, on Feb. 16, 2005). This appears to mean that there is no logical explanation of why long term interest rates fail to rise along with short term interest rates. The method of the present invention demonstrates an explanation of the “conundrum”, in that short term interest funds are separate products from long term interest funds in that there are separate demand and supply curves for each of these products. At the present time the supply of funds for long term investment is plentiful, but banks arbitrarily raise short term “prime rates” and credit card rates for each rise in the Federal Funds rates. Since currently most well run conservative companies have an adequate or excess supply of cash, there is a reduced incentive or demand in the market by companies to borrow. Therefore companies that do borrow are able to borrow at low rates because of the surplus cash availability. The method of the present invention borrows funds from the low cost long term market of primarily mortgage funds and invests it in no-risk or low-risk short term market investments, including but not limited to CDs, government and corporate bonds, and funds that invest in these types of products. While the initial investment in these products involves an actual rate lower than the mortgage rate, the CD rate is not proportionally lower if the term is considered. Under normal circumstances, the rate for fifteen years would be much higher than one or one and one half percent more than the CD rate. In addition to the previously unappreciated effects between simple and compound interest, the unrecognized fact that there are two interest markets is a characteristic of the method of the present invention.

In a preferred embodiment of the present invention, home equity invested at a lower rate earns a greater interest return by borrowing the money at fixed simple interest and investing the money at compound interest, preferably in a CD to minimize investment risk. The results of this method are illustrated in the figures, with a substantial gain accumulated in FIG. 3. The borrowed amount will exceed the invested amount for a short initial period, but the accrued invested amount will be greater after this period. This of course assumes that the borrower makes his monthly mortgage payments when due according to the mortgage or other contract terms. The mortgage principal and the interest decline each month but the invested amount increases or gains as the interest earned is reinvested.

While it is true that simply investing the mortgage payment amount monthly would result in a greater return as per FIG. 4, the homeowner has to make this investment consistently each month for years, whereas using the method of the present invention to borrow one lump-sum amount over a known period of time removes that homeowner variable and provides a no-risk or low risk return with savings accumulation. In addition, having a large amount of funds available initially by borrowing would enable the investor to take advantage of any spike or sharp increase in interest rates at that moment.

Another advantage of borrowing a large sum initially is to take advantage of the higher rates paid on larger CD amounts. The investor has the advantage of having borrowed the funds at a low fixed simple rate for example, fifteen years, and then has fifteen years to wait for that interest spike that will inevitably come, since that period should cover multiple business cycles. Until then, the investor will continue to invest at the best available rates. To keep risk low the investor can also invest in high quality corporate bonds, when those rates rise. This will come sometime after his initial borrowing, since the timing of the low rate borrowing will usually come in a low rate environment, when corporate bond interest is also low. But the borrower would have fifteen years to wait for the opportunity and meanwhile could invest in CDs and still make money as demonstrated.

In a rising interest economy the short-term matured CDs or bonds may be replaced by higher interest paying investments and the initial gap between the mortgage and the investment in the present invention will decrease. Equilibrium, i.e., funds invested equals the mortgage balance, will be attained before the end of the first year. In a falling interest rate environment the matured CDs or bonds may be replaced with longer-term investments with higher rates. The calculations presented in the Figures also show the interest on compounded investments can be at a lower rate than the mortgage rate and still provide gain for the investor. If the situation of falling interest rates creates a large gap between the mortgage rates and the newly available CDs, the borrower-investor can refinance the mortgage and acquire a lower rate. When interest rates rise again, which they inevitably do, the investor is in a better position with a low rate mortgage and higher paying investments such as CDs available. Pursuant to the method of the present invention, the lender is contracted to a specific interest rate, but the borrower is not limited to a predetermined investment interest rate. The borrower benefits from the appreciated value of the real estate but the mortgage lender does not share directly in that benefit.

However, the method of the present invention provides the basis for a no-risk or low-risk investment product that lenders can include in their portfolio of product offerings to customers. A money lender typically makes a profit by retaining a portion of loan expenses and interest paid on the value of the loan. For a typical home or asset equity loan, the money is given to the home owner to spend and the customer must make periodic principal and interest payments according to an amortization schedule. For security to lend the money, the lender typically requires the customer to sign a security instrument evidencing collateral for the loan. In real estate lending this security instrument is generally known as a ‘mortgage.’ By using the product of the present invention, the lender may not only retain a security interest in the property as collateral, but may also retain control of the investment by, for example, requiring that the CDs or investment funds be assigned to them or an affiliate as part of the product package. Since the investment quality is guaranteed and provides a known return, the lender has double collateral for security. Doubling the loan security should decrease if not eliminate defaults, thus further reducing expense to the lender which can be passed onto the customer by lower mortgage rates. The product could be set up to reinvest all gains, or a portion thereof with the balance distributed to the customer over time. Once the loan is repaid and the investments closed, the customer realizes the balance of the undistributed gain, if any.

Utilization of the method of the present invention by commercial lenders including but not limited to qualified financial institutions, banks, mortgage companies, insurance companies and credit unions, provides an advantageous financial product as stated above with minimal or no risk to the investor or the lender for equity lending. A mortgage company could lend money for this type of no-risk or low-risk investment product to encourage accumulation of savings by individuals who otherwise may not be in the borrowing market. The savings product would consist basically of lending money by the method of the present invention to buy a lender controlled investment product, setting up repayment by an amortization schedule and paying the gain to the customer during or at the end of the loan. An investment company could pool the funds of this type of investor to negotiate a better rate deal on CD interest with banks than an individual investor would be able to negotiate. The investment company can also pool its funds to invest in the highly rated bonds without paying the high brokerage fees charged to individuals. Potential borrowers can be solicited from company lists of prior mortgagees who have paid off their mortgages and have good credit ratings, and explained the benefits of this type of low-risk investment.

Another beneficial financial arrangement pursuant to the method of the present invention is that the proceeds of the mortgage loan would be immediately invested in CDs. These CDs would be assignable to the mortgage company, as stated above, in the event that mortgage payments were not made. This would give the mortgage company double collateral, the mortgaged real estate and the CDs. While the mortgage company has the right to foreclose on the real state, sell it and collect the proceeds, this is a time consuming and expensive procedure involving legal expenses and the possibility of a depreciated value of the home. The ability to collect on the CDs would enable the mortgage company to lend the money to the borrower at a much more favorable rate, since this arrangement would represent to the mortgage company an almost “risk free” loan.

Once the CDs reached a predetermined percent of the mortgage balance, the borrower/investor could begin to invest the CD interest in high level (to be agreed upon with the lender) corporate bonds. This would enable the borrower/investor to earn a greater return on the investment and still have the mortgage company collateral protected. Again, once the investments exceeded the mortgage balance by a higher agreed upon percent, the borrower/investor could begin withdrawing some of the excess funds, if agreed in the loan specifics. The mortgage company would be obligated to invest the proceeds for the investor in the highest paying CDs. This obligation would benefit the mortgage company by building equity in the collateral and benefit the borrower/investor by increasing the value of the investment. It may be advisable for the functions of lending and investing be handled by separate departments of the mortgage company.

For taxpayers itemizing deductions, interest expense incurred for the purpose of producing investment income is deductible as an expense on Schedule A as reviewed in Internal Revenue Service (IRS) Publication 936, “Home Mortgage Interest Deduction”, on page 12 at line 13. However, it is necessary in the first year of the loan to include an “election out” statement on your tax return to inform the IRS that the loan was taken out to finance an investment and was not for the normal purposes of a home equity loan. Also, the limit of $50,000 for single filers and $100,000 for joint filers for home equity interest deduction does not apply for loans used for investments. See Publication 936, page 10, “Debt Higher Than Limit”. Since there is a limitation of interest expense to the amount of interest income, the unused interest expense can be carried forward to future years. See Publication 550, pages 34 and 35. Interest expense cannot be taken to finance the interest income on tax-free investments. Id. at pages 32 to 34. Thus under the current IRS rules, the excess of interest income over interest expense of the present invention would be taxable at the ordinary income rate. Taxpayers who take the standard deduction and do not itemize do not get the advantage of home mortgage interest expense and real estate taxes. However the disciplined investor utilizing the method of the present invention can simply use the interest earned to offset personal expenses and put the amount of interest earned into a “Roth” type IRA and only pay taxes on the current year's interest income while all future accumulations will be tax free or put that amount into a 401 K or traditional IRA and get a deduction for that amount that year. Under this second method, the interest will accumulate tax deferred.

Therefore, it is an object of the present invention to provide a low-risk or no-risk method of investing home equity to generate a gain by use of a simple fixed interest rate mortgage and the loan proceeds after lending expenses invested in low-risk or no-risk products at compound interest income to realize a gain in excess of the borrowed interest.

It is a further object of the present invention to provide a method of accumulating savings or gain in an investment that is no-risk or low-risk that utilizes equity in property, real or personal.

It is a further object of the present invention to provide a no-risk or low-risk investment loan product for lenders to offer to customers to encourage personal savings and therefore wealth creation.

### BRIEF DESCRIPTION OF THE FIGURES

FIG. 1 is an amortization schedule of a $100,000.00 loan amount borrowed at a rate of five percent (5%) simple fixed interest and repayable over 15 years (180 payments) in accord with the present invention;

FIG. 2 is a table comparing in Column 1 a mortgage balance of $100,000.00 borrowed at five percent (5%) simple fixed interest over fifteen years, with a three percent (3%) finance charge, to a minimum investment balance return of 2.6 percent (2.6%) compound interest in Column 2 with reinvestment of principal and interest, in accord with the present invention;

FIG. 3 is a table comparing in Column 1 a mortgage balance of $100,000.00 borrowed at five percent (5%) simple fixed interest over fifteen years, with a three percent (3%) finance charge, to an investment balance return of 4.0 percent (4.0%) in Column 2 with reinvestment of principal and interest, in accord with the present invention;

FIG. 4A is a table comparing an annual investment of an amount equal to the mortgage payment of FIG. 1 at 4% compound interest over 15 years, versus the investment method of the present invention at 4% as shown in FIG. 3 in accordance with the present invention;

FIG. 4B is similar to FIG. 4A, but providing the investment method of the present invention at 4.6% as shown in FIG. 3 in accordance with the present invention.

### DETAILED DESCRIPTION OF THE INVENTION

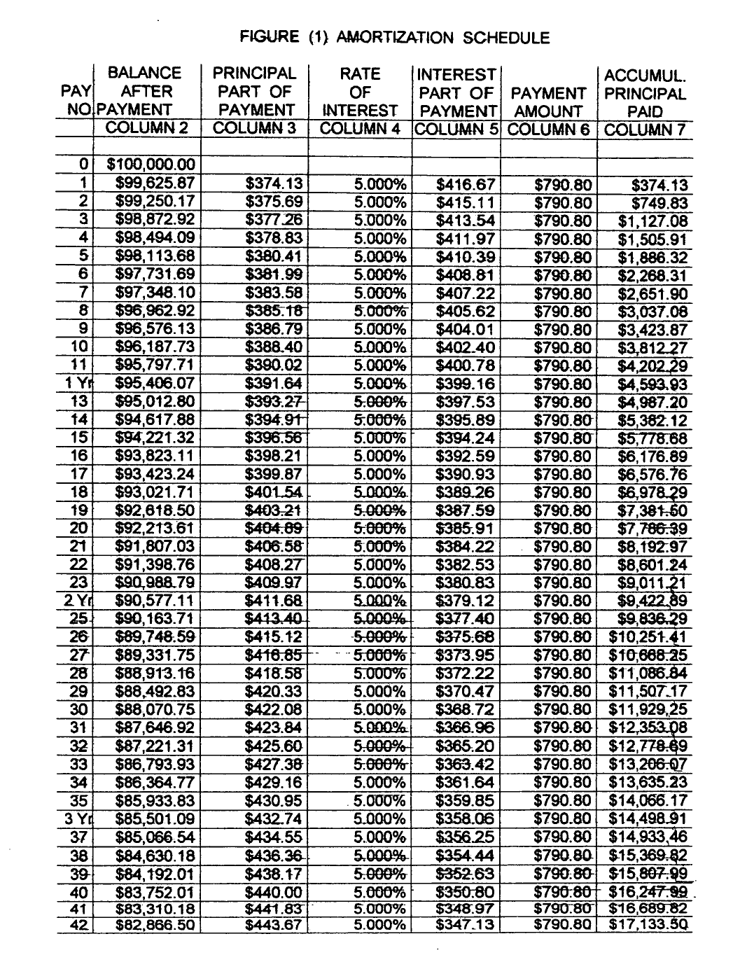

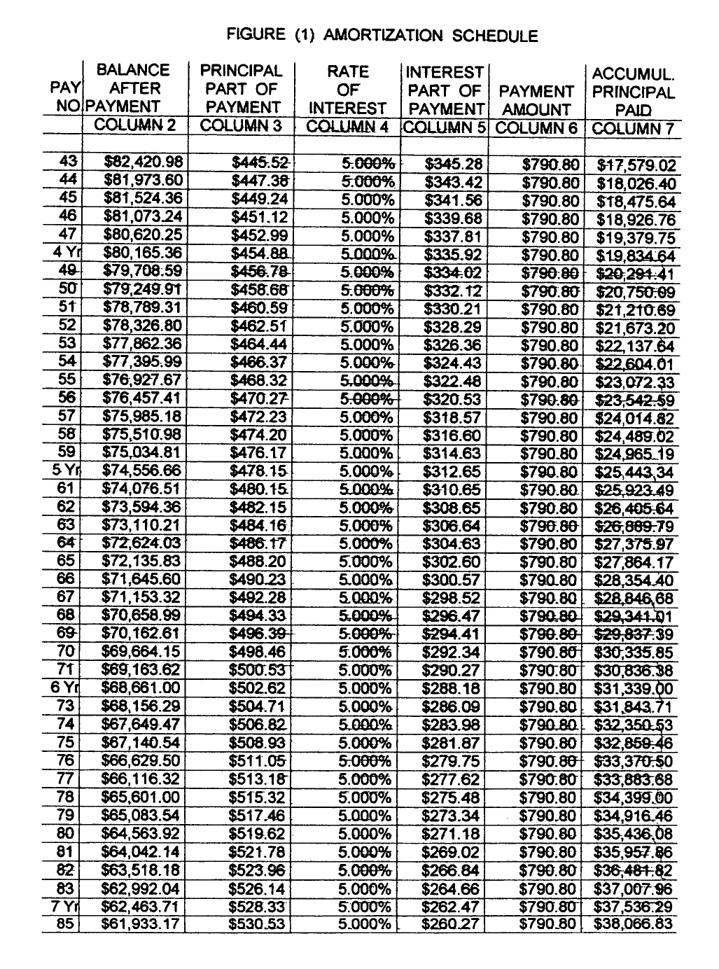

Proceeding now to the figures, FIG. 1 provides a reference amortization schedule, known in the art, of a $100,000.00 principal loan amount borrowed at a rate of five percent (5%) simple fixed interest (Column 5) and repayable over fifteen (15) years (180 payments). Column 1, “Pay No.”, is the numerical sequence of the periodic payments. Column 2, “Balance After Payment,” provides the declining principal loan balance throughout the fifteen year term eventually reduced to zero. This value was obtained by deducting the principal portion of the payment in Column 3 from the previous balance in Column 2. Columns 3 and 5 illustrate the corresponding principal and interest portions of the periodic payments in Column 6. The amount in Column 3 was obtained by deducting the interest portion from the payment amount of $790.80. Similarly, Column 5 is the difference between Column 6 and Column 3. For example in payment 39, to determine the amount in Column 2, the principal portion of payment 39, $438.17, is deducted from the previous balance in column 2 for payment 38, $84,630.18, to obtain the balance in payment 39 of $84,192.01. In Column 7, “Accumulated Principal Paid,” recites the accumulated principal over the fifteen year term of the loan eventually equaling the amount of the loan. This amount was obtained by adding the principal portion of the payment to the previous total of the monthly principal amount. For example, add the principal portion of the tenth payment, $388.40, to the previous total of the principal in payment 9 in Column 7, $3,423.87, for a result for payment 10 of $3,812.27.

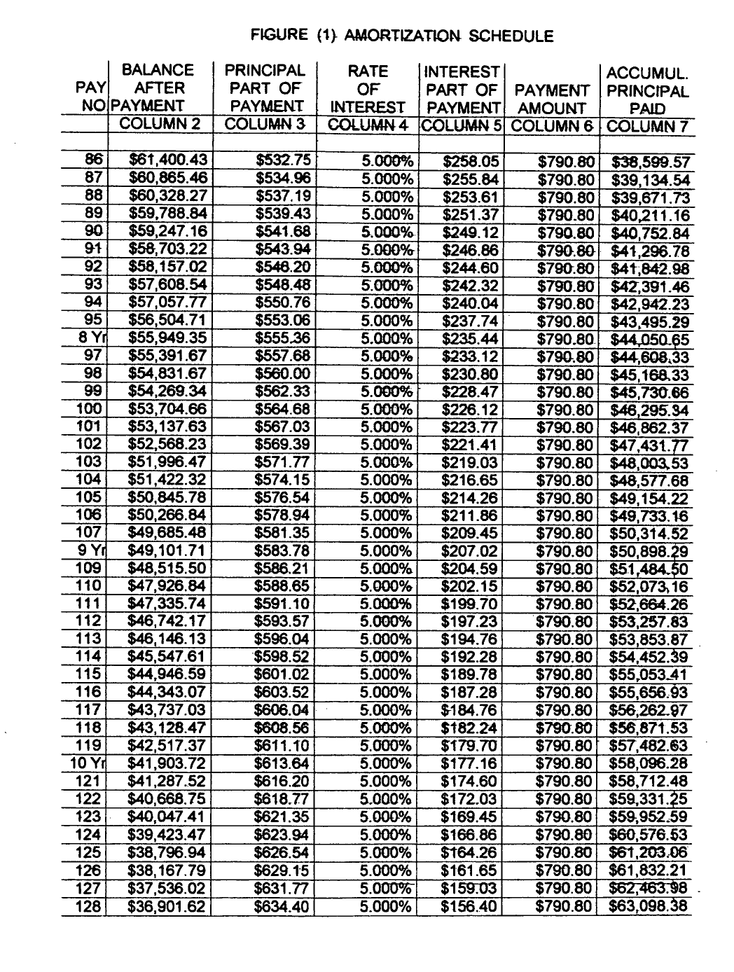

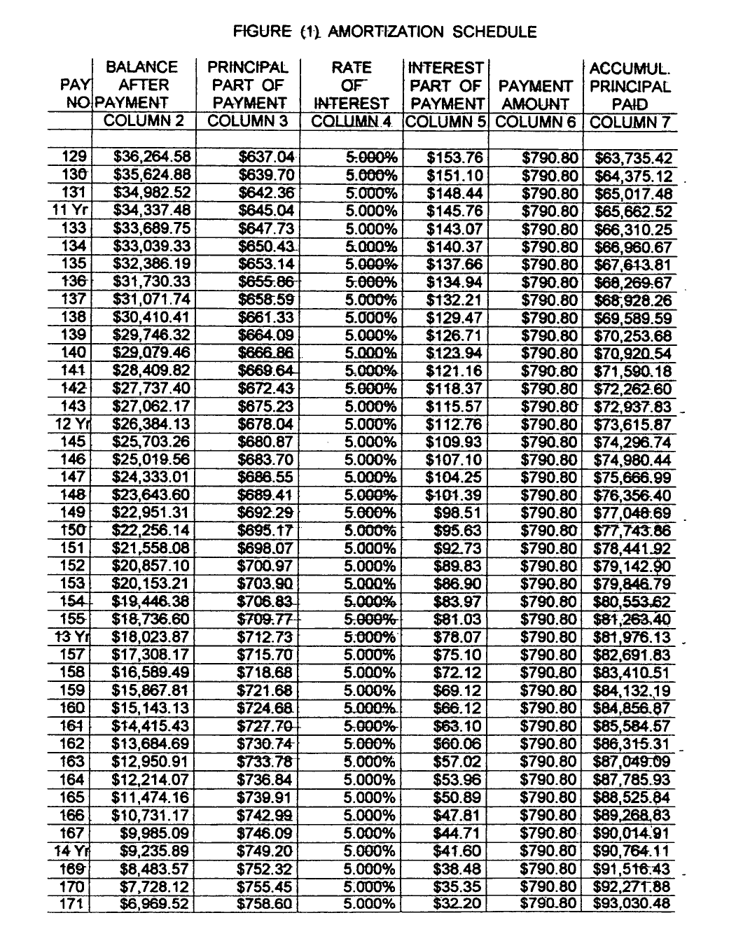

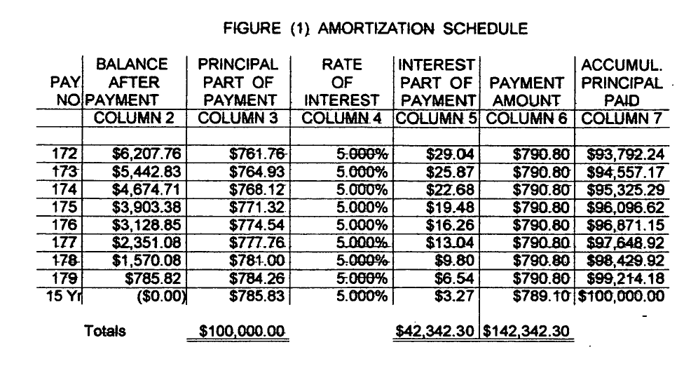

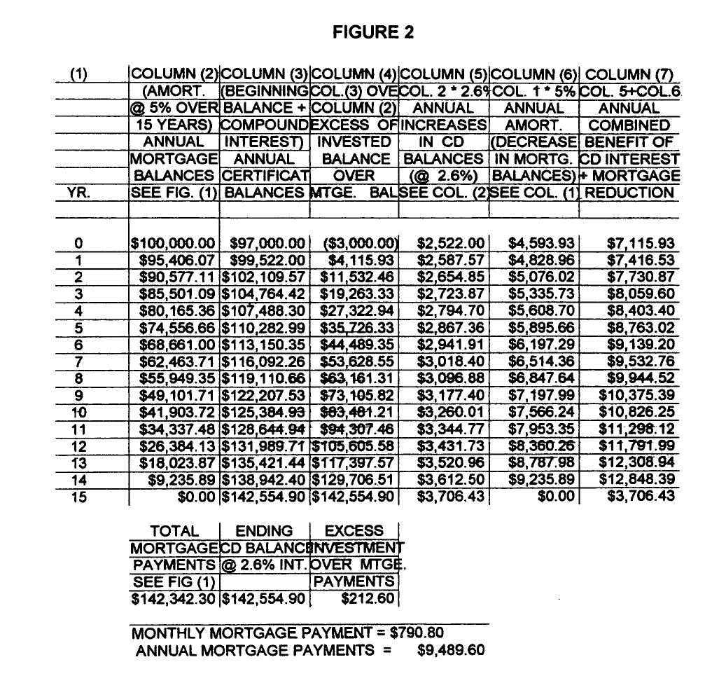

FIG. 2 illustrates a preferred embodiment of the method of the present invention wherein a gain is realized at a CD compound investment rate (2.6%) slightly over half the mortgage borrowing rate (5%) at simple fixed interest. FIG. 2 shows a comparison of mortgage balances to investment balances by year, assuming monthly payments on the mortgage loan balance and reinvestment of matured CDs, plus interest, which demonstrates the workability of the method even under exaggerated differences of an interest spread of 5% mortgage interest and 2.6% investment interest, including three percent (Texas Legal Limit) financing charge deducted from loan proceeds. In FIG. 2 the ratio of investment interest to mortgage loan interest is 52%. The total payments of $142,342.30 made to pay off the $100,000.00 borrowed at the 5% simple fixed interest rate over 15 years are compared to the funds accumulated over the same period, in the amount of $142,554.90, by investing the loan proceeds in CDs. The results demonstrate a net gain of $212.60 at comparative rates of 5% simple to 2.6% compound interest, or a minimum of an investment compound rate slightly greater than fifty (50) percent of the loan simple interest rate.

The table comprises a fifteen year comparison of the 5% annual mortgage balances of FIG. 1 (after a three percent (3%) finance charge), to a minimum investment balance return at 2.6% in Column 5 with reinvestment of principal and interest, in accord with the investment method of the present invention. The comparison demonstrates that by using the method of equity investment of the invention, it is possible to cover the entire amount of the mortgage payments by even a very low compound interest rate for the CDs.

Mortgage interest rates and CD interest rates fluctuate in response to interest rates set by the federal government, the market and the needs of the lender. Mortgage rates may vary with the cost of funds from the Federal Reserve Bank, the length of the loan, the customer credit rating, etc. CD rates may vary over time depending upon which bank is selling the CD, as individual bank rates vary from week to week depending on the cash and borrowing needs of the bank. Longer term CD interest rates are not necessarily always higher than shorter term CD interest rates. The individual lender makes a determination of its needs over the short term and the long term. Investors in a rising interest rate environment will invest short term so that when the CD matures they can then take advantage of the anticipated increases in interest rates. Conversely, a prudent investor would buy long term CDs when it is believed that interest rates have peaked and they want to maintain that rate, or are satisfied with that rate going forward. Therefore, the benefits of the present invention producing a significant investment profit may be achieved by utilizing short or long term CDs.

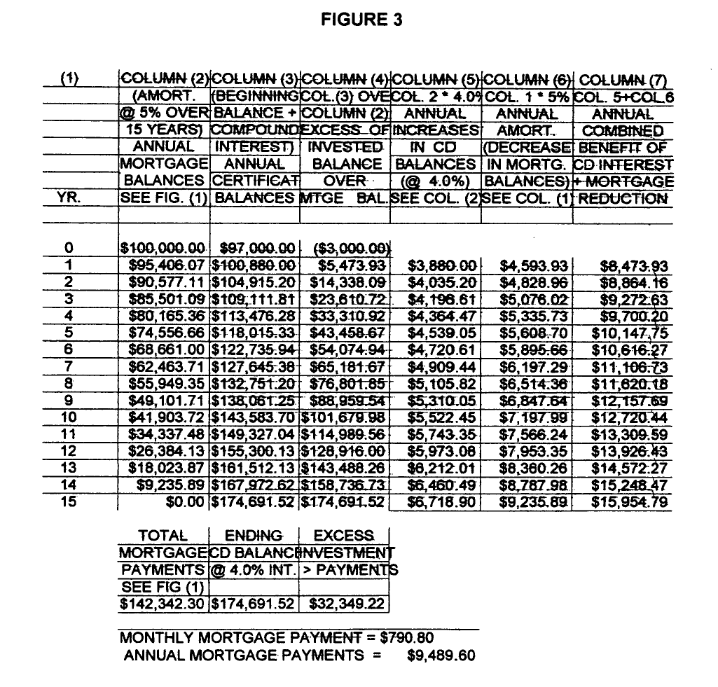

In the further embodiment of FIG. 3, utilizing a more normally encountered interest rate spread of 80% of the loan rate, i.e., 5% simple interest for the borrowing rate and 4.0% compound interest for the investment rate, with reinvestment of principal and interest as in FIG. 2 a surplus of $32,349.22 over the total mortgage loan payments is realized by the method of the present invention. This comparison of mortgage loan balances to investment balances by year assumes monthly payments according to an amortization schedule and reinvestment of matured CDs plus interest, and demonstrates the workability of the system even under a more normally encountered spread between mortgage loan interest (5%) and investment interest (4.0%) with a three percent finance charge deducted from loan proceeds. In FIG. 3 the ratio of investment interest to mortgage loan interest is 80%. Thus the higher the ratio the greater the gain. Although FIGS. 1-3 utilize a common duration of fifteen years for the loan period, a plurality of time periods may be utilized, including but not limited to a range of five to fifty years, provided that the investment rate at compound interest provides a gain in excess of the loan at simple interest and expenses.

Note that FIGS. 2 and 3 utilize a static investment rate throughout the 15 year term. It is more likely that with the use of 5-year or longer CDs, higher interest rates would be available at their respective maturities thus producing even greater surplus or gain because the borrowed rate remains at the original level throughout the term of the loan. A lending and/or savings financial product based upon the method of the present invention would provide double security as collateral for the loan and be offered to, for example, non-sophisticated investors as a no-risk or low-risk investment or savings plan based upon personal and/or real property equity. The double security is provided to the lender by the borrower granting a security interest in the collateral (a mortgage on real property) and the lender controlling the investment in the CDs.

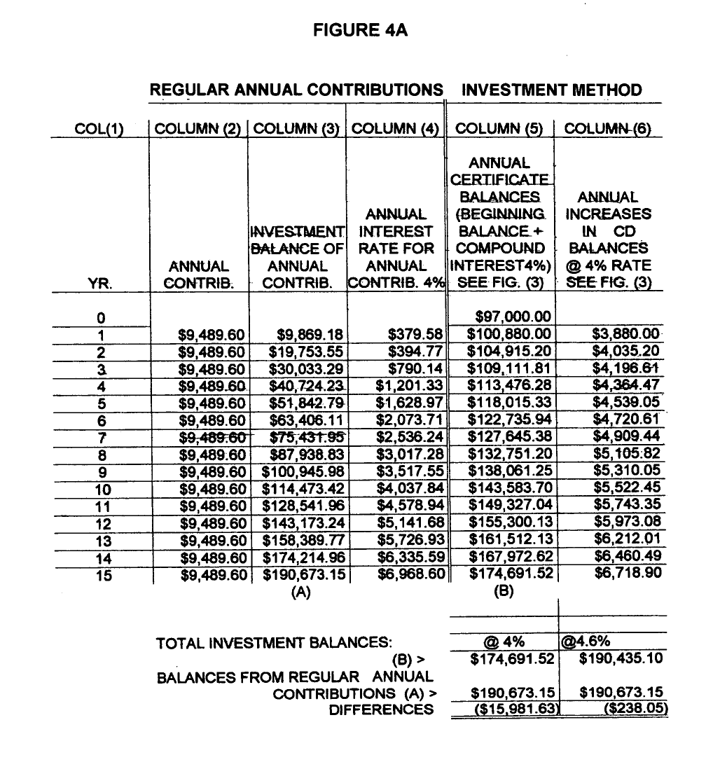

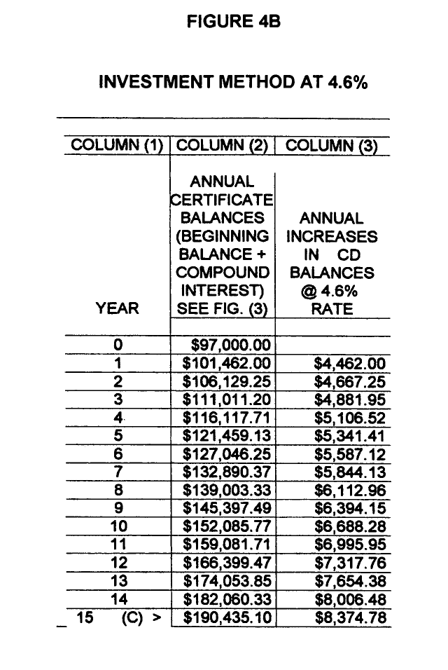

FIG. 4A shows both the annual and the method of the invention investing at 4%. FIG. 4B shows the annual investment rate at 4% and the method of the invention at 4.6% to equal the return on the annual method. FIG. 4A and 4.6% in FIG. 4B are examples of a sophisticated and disciplined investment regimen. In contrast to the preferred embodiment of the present invention, wherein even an unsophisticated investor would realize a low-risk gain by borrowing one lump sum and investing the proceeds as described. Thus this schedule demonstrates that investing the same amount of a mortgage payment annually would result in a greater return assuming a consistent interest rate (4%) but the difference is too small to compensate for the advantages of the preset invention having larger amounts available sooner to invest at higher rates for longer periods when interest rates rise. The advantages and strategies of borrowing a large sum initially can easily overcome the six-tenths of a percent advantage of the annual investment method.

It is understood that the embodiments and descriptions of the invention herein described are merely instruments of the application of the invention and those skilled in the art should realize that changes may be made without departure from the essential elements and contributions to the art made by the teachings of the invention herein.

What is claimed is:

1. A method of investing for gain comprising:
a. Borrowing an amount of money at a simple fixed interest rate for a predetermined period of time,
b. Amortizing repayment of said borrowed money further comprising scheduling periodic payments of principal and interest over said period of time,
c. Repaying said borrowed money according to said amortization schedule further comprising payments of said principal and interest,
d. Investing said borrowed money at a compound interest rate,
e. Providing an investment return on said borrowed money greater than said principal and interest repayment over said period of time,
f. Completing said repayment of said borrowed money and simple interest,
g. Realizing an amount of money from said investment in excess of said repayment obligation;

2. The method of claim 1 wherein said borrowed money comprises an amount calculated from equity value in personal property;

3. The method of claim 1 wherein said borrowed money comprises an amount calculated from equity value in real property;

4. The method of claim 1 wherein said compound interest rate comprises a rate in excess of fifty-five percent of said simple fixed interest rate;

5. The method of claim 1 wherein said value of said investment at compound interest is insured;

6. The method of claim 1 wherein said investment is a Certificate of Deposit;

7. The method of claim 1 wherein said period of time comprises a plurality of years;

8. The method of claim 1 wherein said period of time comprises a range of five to fifty years;

9. A low risk method of real property equity investing for gain comprising:
a. Borrowing from a lender an amount of money calculated from equity value in real estate at a simple fixed interest rate for a predetermined period of time,
b. Pledging said real estate as collateral for borrowing said money,
c. Amortizing repayment of said borrowed money by scheduling periodic payments of principal and interest over said period of time,
d. Repaying said borrowed money according to said amortization schedule by payments of said principal and interest,
e. Investing said borrowed money at a compound interest rate in one or more Certificates of Deposit,
f. Pledging said Certificate of Deposit as collateral for borrowing said money,
g. Reinvesting gain from said Certificate of Deposit,
h. Providing an investment return on said borrowed money greater than said principal and interest repayment over said period of time,
i. Completing said repayment of said borrowed money and interest expense,
j. Closing said Certificate of Deposit,
k. Releasing said real estate collateral,
l. Realizing an amount of money from said investment in excess of said repayment obligation;

10. The method of claim 9 wherein said compound interest rate comprises a rate in excess of fifty-five percent of said simple fixed interest rate;

11. The method of claim 9 wherein said value of said investment at compound interest is insured;

12. The method of claim 9 wherein said period of time comprises a plurality of years;

13. The method of claim 9 wherein said period of time comprises a range of five to fifty years;

14. A method of saving money comprising:
a. Borrowing an amount of money from a lender at a simple fixed interest rate for a predetermined period of time,
b. Repaying said borrowed money further comprising periodic payments of said principal and interest,
c. Investing said borrowed money at a compound interest rate,
d. Providing an investment return on said borrowed money greater than said principal and interest repayment over said period of time,
e. Realizing an investment gain in excess of said repayment obligation;

15. The method of claim 14 wherein said compound interest rate comprises a rate in excess of fifty-five percent of said simple fixed interest rate;

16. The method of claim 14 wherein said value of said investment at compound interest is insured;

17. The method of claim 14 wherein said period of time comprises a plurality of years;

18. The method of claim 14 wherein said period of time comprises a range of five to fifty years;

19. A method of low risk equity lending for a lender in a loan comprising:
a. Securing rights by the lender to an asset of a borrower,
b. Lending an amount of money to said borrower further comprising a portion of equity in said asset,
c. Amortizing repayment of said amount of money over time further comprising periodic payments of principal and fixed simple interest by said borrower,
d. Investing the proceeds of said loaned money in a lender-controlled product paying a compound interest rate on said proceeds,
e. Reinvesting gain from said lender-controlled product,
f. Providing an investment return to said borrower greater than said repayment obligation of said principal and interest repayment over said period of time,
g. Completing said repayment of said borrowed money and interest expense,
h. Closing said loan,
i. Releasing said secured rights in said asset of said borrower,
j. Paying said equity investment gain to said borrower;

20. The method of claim 19 wherein said compound interest rate comprises a rate in excess of fifty-five percent of said simple fixed interest rate;

21. The method of claim 19 wherein said value of said investment at compound interest is insured;

22. The method of claim 19 wherein a portion of said gain is distributed during the tenure of said loan;

23. The method of claim 19 wherein said period of time comprises a plurality of years;

24. A low risk equity investment savings product for a lender comprising:
a. A loan at a simple fixed interest rate of an amount of money calculated as a portion of equity in an asset of the saving customer,
b. An amortization schedule for repayment of said loan amount principal and interest over a period of time,
c. An investment return on said loan amount greater than said repayment obligation of said principal and interest repayment over said period of time, further comprising a lender-controlled product paying a compound interest rate and reinvesting gains over said period of time,

25. The method of claim 24 wherein said compound interest rate comprises a rate in excess of fifty-five percent of said simple fixed interest rate;

26. The method of claim 24 wherein said value of said investment at compound interest is insured;

27. The method of claim 24 wherein said period of time comprises a plurality of years;

28. The method of claim 24 wherein said period of time comprises a range of five to fifty years;
